(19) United States
(12) Patent Application Publication
(10) Pub. No.: US 2004/0205540 A1
(43) Pub. Date: Oct. 14, 2004

(54) Document management system

(76) Inventors: Michael Vulpe, Toronto (CA); Tim Sweet, Toronto (CA); Alexander Karvasarski, Toronto (CA)

Correspondence Address: GOWLING LAFLEUR HENDERSON LLP, COMMERCE COURT WEST, SUITE 4900, TORONTO, ON, M5L 1J3, CA

(21) Appl. No.: 10/013,479

(22) Filed: Dec. 13, 2001

(51) Int. Cl. G06F 7/00

(52) U.S. Cl. 715/511; 707/104.1; 715/524

(57) ABSTRACT

A document management system for managing a plurality of documents includes a document intersection database, and a document manager in communication with the document intersection database. The document intersection database defines a document intersection space for the documents. One of the document intersection spaces defines document architecture data and/or document content data of one of the documents and at least one other document associated with the one document. The architecture data defines a document architecture of the associated document, whereas the content data defines content for the associated document. The document manager is configured to update the one document intersection space with document data received from the one document and to notify the other of the documents of the update to the one document intersection space.

### FIELD OF THE INVENTION

The present invention relates to a method and system for document management. In particular, the present invention relates to a document management system which synchronizes the content and architecture of related documents.

### BACKGROUND OF THE INVENTION

The proliferation of computer systems in the workplace, and the ease with which such systems have provided users with access to information electronically, has brought with it a need for computerized systems which can organize, store and retrieve the information in electronic documents. The conventional electronic document management system maintains a document space, controls access to documents in the document space, provides version control of the documents, and allows users to categorize the documents in accordance with predefined properties, such as author, subject matter, and revision status, for subsequent storage and retrieval.

Although the conventional electronic document management system reduces the resources which would otherwise be necessary to maintain and organize large collections of electronic documents, the conventional electronic document management system still imposes a significant administrative burden on users of documents in the document space. For instance, if the physical location or name of a document is changed, or if the document itself is changed, the authors of all other documents in the document space must be notified of the change, as is appropriate, if currency is to be maintained. Consequently, attempts have been made to reduce the administrative burden imposed on users by the conventional document management system.

Microsoft introduced embedded linked objects (OLE) as a mechanism to allow content to be shared between documents. According to this methodology, a document created with one software application can have embedded links to objects created with other software applications. Consequently, changes made to the embedded objects are automatically carried forth to the linking document when loaded by its native application. Although OLE allows one document to refer to other documents, OLE does not allow the content of one document to be linked with the content of another document.

Petersen (U.S. Pat. No. 6,308,179) teaches a document management system which separates the content of a document from its properties, such as its location in a file system, its author, and its revision status. The document management system allows users to create reference documents which includes links to base documents, thereby allowing documents to be stored, retrieved and re-organized in a manner which is not dependent upon the organizational structure imposed by the author of the base document.

Thornton (U.S. Pat. No. 6,240,429) and Dourish (U.S. Pat. No. 6,253,217) both teach document management systems which allow a user to attach active properties to a document. Attaching an active property to a document forms an association between the property and the document. In Thornton, the active properties include executable code which activates an external service in response to a user-defined triggering event, such as an operation performed on the document. When the operation is performed, the system checks the document's active properties to determine if the operation was a triggering event. If so, the executable code invokes the external service, the results of which are then sent back to the document management system. In this way, the document management system provides the user with access to services external to the management system, without requiring the user to specifically invoke the external service.

For instance, an active property can be attached to a document which translates the content of the document from English to French, and the triggering event could be a “read content” operation. Consequently, when a user uses an application program, such as a word processor, to read the content of the document, the document management system intercepts the “read content” attempt, and causes a translation application to be invoked to thereby translate the document from English to French. When the translation is complete, the document management system provides the word processor with a French translation of the document, with the word processor and the user remaining unaware of the translation operation and the fact that the document was originally written in English.

In Dourish, the active properties include executable code which changes the system configuration of the document in response to a user-defined triggering event. Typical system configuration parameters include the location of a document, its access level, backup frequency, and version retention. When a triggering event is performed, the document management system executes the code associated with the active property, thereby altering the designated system configuration. For example, a system configuration could be an alternate storage server, and the triggering event could be the failure of the primary storage server. Thus, when the primary storage server fails, the document management system would being using the alternate server for storing files.

Although Petersen, Thornton and Dourish reduce the burdens typically imposed on users by conventional document management systems, associations are established based on properties which are external to the document itself. Consequently, it is not possible for the content or architecture of related documents to be linked.

### SUMMARY OF THE INVENTION

According to the invention, there is provided a document management system and a method of document management which synchronizes the architecture and content of associated documents. To do so, the document management system maintains a “document intersection space” of the documents managed by the document management system. As used herein, the phrase “document intersection space” refers to the intersection of, or the link between, the architecture and/or content of one document and the architecture and/or content of another document. The document management system is configured to receive document architecture and/or document content updates, to update the document intersection spaces associated with the document updates, and to notify the other documents which are members of the updated document intersection spaces of the changes to their respective document intersection spaces. In this manner, the document management system is able to synchronize or link changes in the architecture and content of associated documents.

According to a first aspect of the present invention, there is provided a method of managing a plurality of electronic documents. The method includes the steps of (1) receiving over a network a document activity indication of one of the electronic documents; (2) identifying a document intersection space associated with the one electronic document, the document intersection space defining document architecture data and/or document content data of the one electronic document and at least one other of the documents associated with the one electronic document, the architecture data defining a document architecture of the associated document, the content data defining content for the associated document; and (3) effecting an update of the one electronic document over the network from the document data of the document intersection space.

According to a second aspect of the present invention, there is provided a method of managing a plurality of electronic documents. The method includes the steps of (1) receiving a document activity indication of one of the electronic documents; (2) from a document intersection database comprising at least one document intersection record, identifying an associated one of the document intersection records associated with the one document, the associated one document intersection record defining document architecture data and/or document content data of the one document and at least one other of the documents associated with the one document, the architecture data defining a document architecture of the associated document, the content data defining content for the associated document; and (3) providing document update data in accordance with the document intersection data.

According to a third aspect of the present invention, there is provided a document management system for managing a plurality of documents. The document management system includes a document intersection database, and a document manager in communication with the document intersection database. The document intersection database defines a document intersection space for the documents. One of the document intersection spaces defines document architecture data and/or document content data of one of the documents and at least one other document associated with the one document. The architecture data defines a document architecture of the associated document, whereas the content data defines content for the associated document. The document manager is configured to update the one document intersection space with document data received from the one document and to notify the other of the documents of the update to the one document intersection space.

According to a fourth aspect of the present invention, there is provided a document management system for managing a plurality of documents. The document management system includes a document intersection database, and a document manager in communication with the document intersection database. The document intersection database includes at least one document intersection record. One of the document intersection records defines document architecture data and/or document content data of one of the documents and at least one other of the documents associated with the one document. The architecture data defines a document architecture of the associated document, whereas the content data defines content for the associated document. The document manager is configured to update the one document intersection record with document data received from the one document and to notify the other of the documents of the update to the one document intersection record.

According to a fifth aspect of the present invention, there is provided a document intersection database for use by a document management system for managing a plurality of documents. The database includes an intersection rule database, and an intersection instance database. The intersection rule database includes at least one intersection rule record. Each intersection rule record defines a document intersection space comprising one of the documents and at least one other of the documents associated with the one document. The document intersection space defines a map between document architecture data of the one document and the associated documents. The intersection instance database includes at least one intersection instance record. Each intersection instance record is associated with one of the document intersection spaces and defines document content for the document architecture of the one document intersection space.

According to a fifth aspect of the present invention, there is provided a computer-readable medium for providing processing instructions in a computer. The processing instructions causes the computer to perform the steps of (1) receiving over a network a document activity indication of one of the electronic documents; (2) identifying a document intersection space associated with the one electronic document, the document intersection space defining at least one of document architecture data and document content data of the one electronic document and at least one other of the documents associated with the one electronic document, the architecture data defining a document architecture of the associated document, the content data defining content for the associated document; and (3) effecting an update of the one electronic document over the network from the document data of the document intersection space.

According to a sixth aspect of the present invention, there is provided a computer-readable medium for providing processing instructions in a computer. The processing instructions causes the computer to perform the steps of (1) receiving a document activity indication of one of the electronic documents; (2) from a document intersection database comprising at least one document intersection record, identifying an associated one of the document intersection records associated with the one document, the associated one document intersection record defining at least one of document architecture data and document content data of the one document and at least one other of the documents associated with the one document, the architecture data defining a document architecture of the associated document, the content data defining content for the associated document; and (3) providing document update data in accordance with the document intersection data.

### BRIEF DESCRIPTION OF THE DRAWINGS

The present invention will now be described, by way of example only, with reference to the accompanying drawings, in which:

FIG. 1 is a schematic view of the document management system, depicting the access terminals and the document intersection database;

FIG. 2 is a schematic view of one of the access terminals shown in FIG. 1;

FIG. 3a is a sample metacode listing which identifies the architecture for documents of the document class “robot_costing”;

FIG. 3b is a is a sample metacode listing which identifies the content for a document of the document class “robot_costing”;

FIG. 4a is a sample metacode listing which identifies the architectural rules for documents of the document class “robot_drawing”;

FIG. 4b is a is a is a sample metacode listing which identifies an instantiation of the architecture and the content for a document of the document class “robot_drawing”;

FIG. 5a is a sample metacode listing which identifies the architectural rules for documents of the document class “intersection_specification”;

FIG. 5b is a sample metacode listing for an intersection rule record of the document intersection database as an instantiation of the architecture;

FIG. 6a is a sample metacode listing which identifies the architecture rules for documents of the document class “intersection_record”;

FIG. 6b is a sample metacode listing for an intersection instance record of the document intersection database as an instantiation of the architecture;

FIG. 7 is a generalized flowchart depicting the operation of the document management system;

FIG. 8 is a detailed flowchart depicting the operation of the document management system when the document “f:\documentsample1” on the first access terminal is opened;

FIG. 9a is a sample metacode listing which depicts the architectural rules of the document “f:\documentsample1” both before and after the document is opened;

FIG. 9b is a table which identifies an instantiation of the architecture and the content of the document “f:\documentsample1” both before and after the document is opened;

FIG. 10 is a sample metacode listing which depicts an instantiation of the architecture and the content of an intersection instance record both before and after the document “f:\documentsample1” is opened;

FIG. 11 a is a detailed flowchart depicting the operation of the document management system when the document “f:\documentsample1” is edited;

FIG. 12 is a sample metacode listing which depicts the architecture and the content of an intersection instance record both before and after the document “f:\documentsample1” is edited;

FIGS. 13a and 13b together comprise a detailed flowchart which depicts the operation of the document management system when the document “c:\robot.cad” on the second access terminal is opened and then edited;

FIG. 14 is a sample metacode listing which depicts the architecture and the content of an intersection instance record both before and after the document “c:\robot.cad” is edited;

FIG. 15a depicts the architecture of the document “c:\robot.cad” both before and after the update to the document; and

FIG. 15b depicts the content of the document “c:\robot.cad” both before and after the update to the document.

### DETAILED DESCRIPTION OF THE PREFERRED EMBODIMENTS

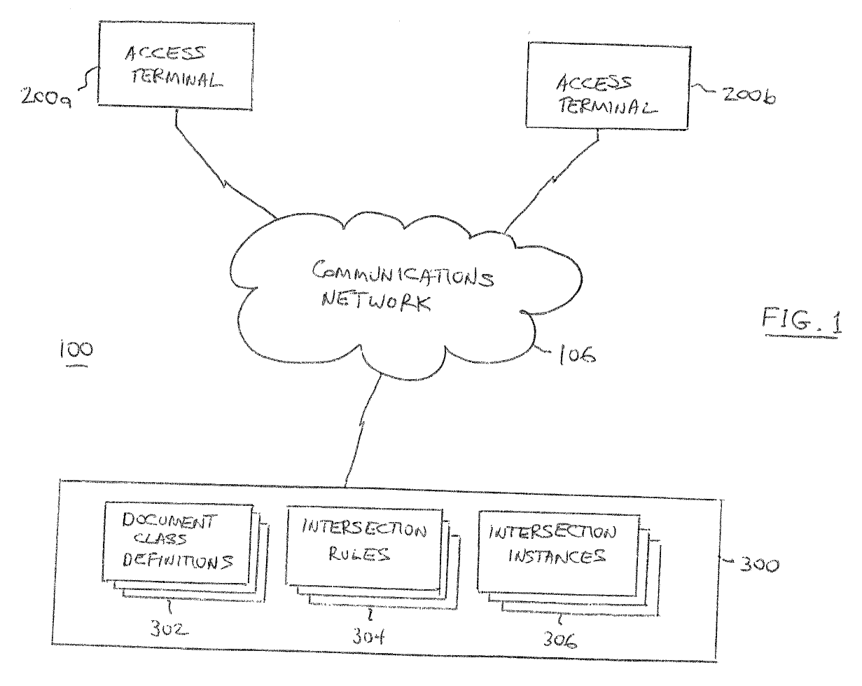

Turning to FIG. 1, a document management system, denoted generally as 100, is shown consisting of document access/editing terminals 200, a document intersection database 300, and a communications network 106 for facilitating communication between the access terminals 200 and the document intersection database 300. Although the document management system 100 is shown having several access terminals 200, it should be understood that the document management system 100 can function with as little as a single access terminal 200. Further, although the document management system 100 is shown having a single document intersection database 300, the document management system 100 can have several document intersection databases 300. Alternately, the document intersection database 300, as a separate element, can be eliminated altogether, with the functions of the document intersection database 300 being spread over one or more of the access terminals 200. In addition, in its most minimal configuration, the document management system 100 consists of only a single access terminal 200, with the access terminal 200 performing the functions typical of this element (described below) in addition to the functions of the document intersection database 300.

Typically, the communications network 106 is a land-based network, however the communications network 106 may instead be implemented as a wireless communications network, or as a combination of land-based and wireless networks as the bandwidth and the types/sizes of the documents to be managed permits. Typically, the communications network 106 is implemented as a wide area network or a local area network, however if the document management system 100 has its most minimal configuration, described above, the communications network 106 may be implemented as a local computer bus. In this latter variation, the access terminals 200 and the document intersection database 300 shown in FIG. 1 would not be representative of separate elements, but instead would represent the different processes performed by the single access terminal 200, with each process being in communication with each other over the local computer bus 106. Further, it should be understood that the communications network 106 need not consist of only a single network type, but instead may be implemented as any of a number of local area networks, wide area networks and local computer bus networks.

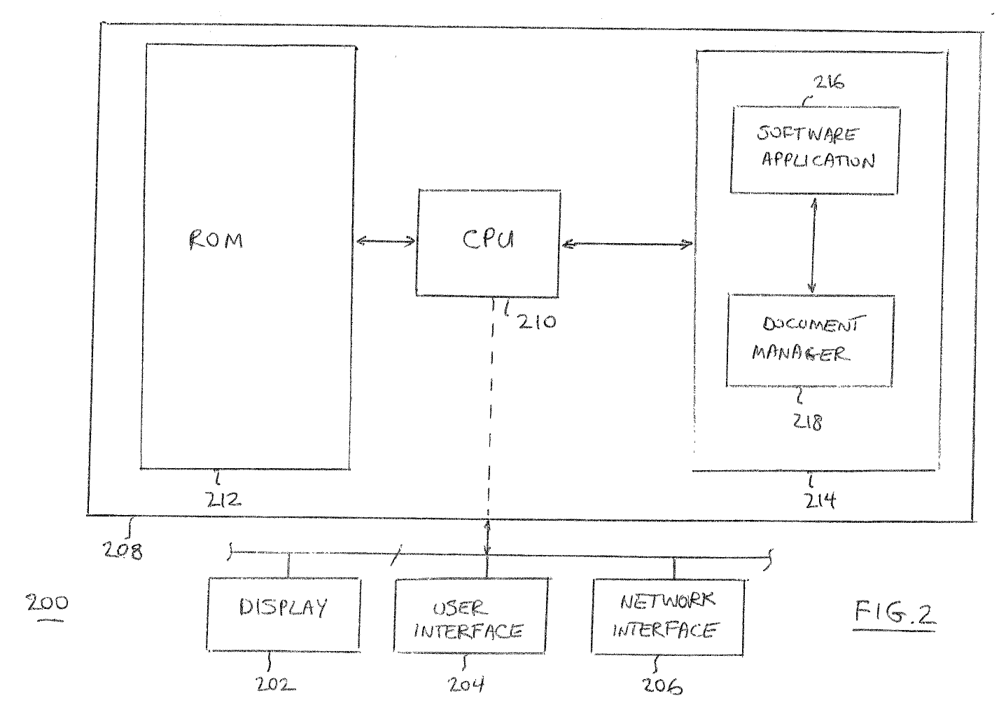

The access terminal 200 is typically provided as a standalone communications device, such as a network-enabled desktop or a network-enabled portable computer. However, the access terminal 200 may also be provided as a handheld wireless communications device, such as a wireless-enabled personal digital assistant (PDA) or wireless telephone. As shown in FIG. 2, the access terminal 200 includes a display 202, a user interface 204, a network interface 206, and a data processor 208 in communication with the display 202, the user interface 204, and the network interface 206. Preferably, the display 202 consists of a CRT monitor or a LCD panel for displaying information thereon.

The user of the access terminal 200 will use the display 202 to view electronic documents managed by the document management system 100. Typically, the electronic documents will consist of documents which can be readily accessed and viewed by software loaded onto the access terminal 200, including word processing documents, spreadsheet documents, flat-file or relational databases, graphical data presentation documents, streaming media, computer aided design documents, and computer source code documents (such as, but not limited to HTML, SMIL, VRML and XML documents). However, it should be understood that the electronic documents envisaged for use with the document management system 100 is not limited to such conventional document forms, but can also include any user-defined data structures which contain data that can be viewed and/or edited with one of the access terminals 200, such as linked lists, binary trees, hash tables, an non-random aggregation of data, and sequential, index or index-sequential computer records.

Preferably, the user interface 204 consists of a computer keyboard, writing tablet, touch-sensitive membrane, or any other suitable input device which allows users of the access terminal 200 to enter information into the access terminal 200, and thereby edit and/or view the documents managed by the document management system 100. The network interface 206 typically comprises a network computer card or wireless-enabled modem for interfacing the access terminal 200 with the communications network 106.

As shown, the data processor 208 consists of a central processing unit (CPU) 210 in communication with the display 202, the user interface 204, and the network interface 206, and anon-volatile memory (ROM) 212 and a volatile memory (RAM) 214 in communication with the CPU 210. The ROM 212 is typically provided as a magnetic and/or optical data storage medium which allows the data stored thereon to be erased and/or updated as commanded by the data processor 208, but retains its data when the electrical power to the access terminal 200 is interrupted. The ROM 212 includes processor instructions for the CPU 210 which establish in the RAM 214 a software application 216, and a memory object defining a document manager 218 in communication with the software application 216 and the document intersection database 300.

Although the document manager 218 is described as being implemented preferably as computer software, it should be understood that the document manager 218 can also be implemented in electronic hardware, or a combination of software and hardware as the application demands. In addition, although the document manager 218 is described as being implemented on each of the access terminals 200, it should be understood that the document manager 218 can instead be implemented on a single one of the access terminals 200, implemented on the computer server (discussed below) which implements the document intersection database 300, or have its functional components distributed over several of the access terminals 200, as long as the software applications 216 of each access terminal 200 are provided with pointers or links to the location of the components of the remote document manager 218 to thereby enable the software applications 216 to access the functionality of the remote document manager 218.

Typically, the document intersection database 300 is implemented as an element which is separate from the access terminals 200. However, as discussed above, the document intersection database 300 can be distributed over one or more of the access terminals 200. Consequently, in this latter variation, in addition to processor instructions for the CPU 210, the ROM 212 includes one or more components of the document intersection database 300. The document intersection database 300 will be described in detail below.

The user of the access terminal 200 uses the software application 216 to open, close, edit and/or view the documents managed by the document management system 100. The software application 216 is also configured to pass access requests for documents to the document manager 218, rather than attempting to obtain access to the requested documents directly, and is also configured to receive the requested documents from the document manager 218. The document manager 218 is configured to update the document intersection spaces associated with the documents managed by the document management system 100, and is also configured to notify the software applications 216 of the changes to the document intersection spaces. As discussed above, the phrase “document intersection space” is used herein to refer to the intersection of, or the link between, the architecture and/or content of one document and the architecture and/or content of one or more associated documents. Consequently, the document manager 218 is configured to receive update information from the software applications 216 which updates the architecture and/or content of the documents accessed by the respective software applications 216, to update the document intersection spaces associated with the document updates, and to notify the other documents (via their respective access terminals 200) which are members of the updated document intersection spaces of the changes to their respective document intersection spaces.

Typically, the document intersection database 300 is implemented on a computer server having a network interface for interfacing the document intersection database 300 with the communications network 106. The document intersection database 300 defines respective document intersection spaces for the documents, with each document intersection space comprising document architecture data and/or document content data of at least two associated documents. The architecture data defines a document architecture for a document, whereas the content data defines the document's content.

As shown in FIG. 1, the document intersection database 300 includes document class definitions 302 for the various types of documents used by the document management system 100. In addition, the document intersection database 300 includes an intersection rule database, and an intersection instance database. The intersection rule database includes a number of intersection rule records 304, each defining a respective document intersection space comprising at least two of the documents managed by the document management system 100. In effect, each intersection rule record defines a map between the document architecture data of one of the documents of the respective document intersection space and at least one other document of the same document intersection space. In addition, each document intersection rule record includes a rule which defines membership within the respective document intersection space.

Preferably, each document intersection rule defines membership within the document intersection space using document class or genre or document type (eg. word processing document, spreadsheet document) as a criteria. However, the intersection rule may instead define membership using other relevant criteria, such as document location, document subject matter and date. Further, preferably each document intersection rule also uses a unique document subspace identifier or document identifier (eg. project type, revision status) as an additional criteria to define membership within the document intersection space, or to define membership within a respective document intersection subspace of the parent document intersection space.

The intersection instance database includes a number of intersection instance records 306. Each intersection instance record 306 is associated with one of the document intersection spaces (or document intersection subspaces if the document intersection rules used the aforementioned document subspace identifier), and defines document content for the document architecture of the associated document intersection space. The content and function of the document intersection database 300, and the concept of the document intersection space may best be understood by way of example. The following example makes use of the XML computer metacode language, however it will be appreciated that other metacode languages or data representation techniques may be used as appropriate.

In this example, the document management system 100 includes a first access terminal 200a, a second access terminal 200b, a computer server implementing the document intersection database 300, and the communications network 106 interconnecting the access terminals 200 and the document intersection database 300. However, as discussed above, the document class definitions 302, the intersection rule records 304 and the intersection instance records 306 may be distributed between the access terminals 200, provided that the software applications 216 of the access terminals 200 are provided with pointers identifying the locations of the various components of the document intersection database 300.

The software application 216 of the first access terminal 200a is assumed to implement the function of a computer assisted drawing (CAD) program, and the software application 216 of the second access terminal 200b is assumed to implement the function of a spreadsheet program. However, as will be appreciated, other forms of software applications 216 may be used. In addition, for convenience, the first access terminal 200a is assumed to have a local copy of a spreadsheet document which can be accessed (viewed and edited) by the spreadsheet program, and the second access terminal 200b is assumed to have a local copy of a CAD document which can be accessed (viewed and edited) by the CAD program. However, it should also be understood that the spreadsheet document and the CAD document need not be stored locally on the respective access terminals 200, but instead may be stored on the document intersection database server, or on any other location accessible via the communications network 106, provided that the respective software applications 216 are provided with information identifying the locations of the desired documents.

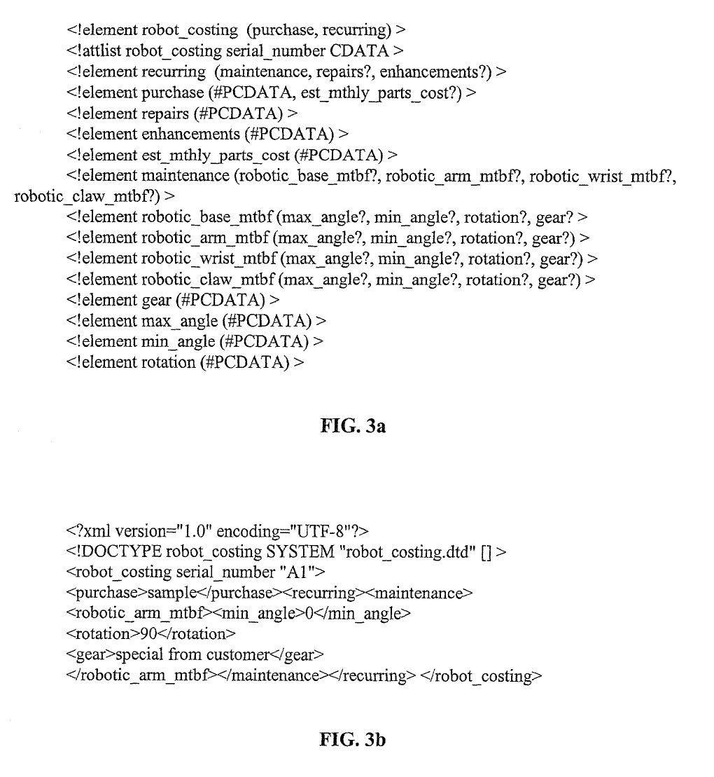

The lines of code shown in FIG. 3a identify the architecture for documents of the document class “robot_costing”. This document is stored on the database server in file “SYSTEM robot_costing.dtd”. Amongst other document elements, the following code defines the variable “robot_costing@serial_number”, and the subparameters “max_angle”, “min_angle”, “rotation” and “gear” of the costing parameter “robotic_arm_mtbf”. As will become apparent, the variable “robot_costing@product_identifier” contains an identifier which is used to determine membership of a document of the class “robot_costing” in a respective document intersection subspace. The costing parameters define variables which can be manipulated by the spreadsheet program, and would be used to determine the cost of a particular widget (in this case, a robot).

The lines of code shown in FIG. 3b define the contents of a document which is stored on access terminal 200a as “f:\documentsample1”. The document identifies itself as a member of the document class “robot_costing”, the class definition of which is stored at “SYSTEM robot_costing.dtd”. Alternately, the metacode definition for the architecture for documents of the document class “robot_costing” could have been embedded directly in the document “f:\documentsample1”. The variable “robot_costing@serial_number”=A1. Also, the costing subparameters of the costing parameter “robotic_arm_mtbf” are: “min_angle”=0; “rotation”=90; “gear”=“special from customer”. The costing subparameter “max_angle” has not been defined.

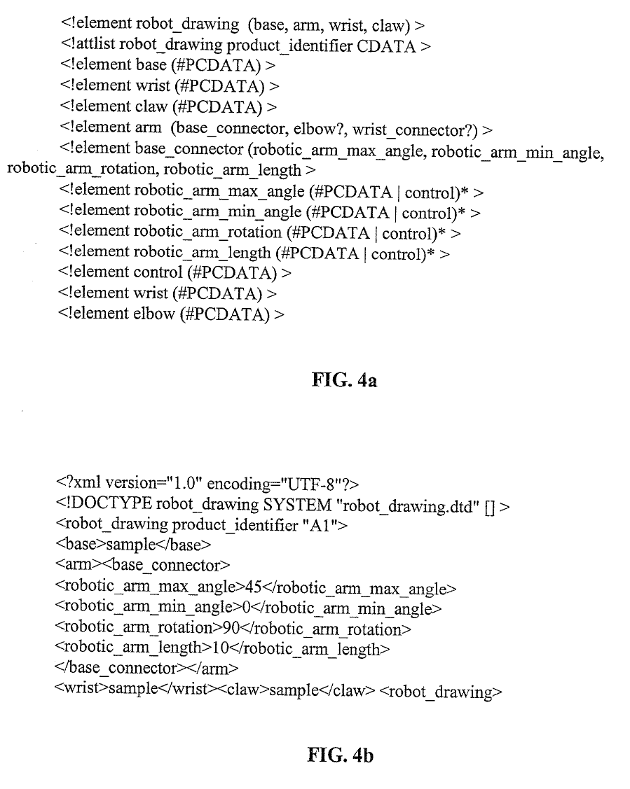

The lines of code shown in FIG. 4a identify the architecture for documents of the document class “robot_drawing”. This document is stored on the database server in file “SYSTEM robot_drawing.dtd”. Amongst other document elements, the following code defines the variable “robot_drawing@product_identifier”, and the drawing parameters “robotic_arm_max_angle”, “robotic_arm_min _angle”, “robotic_arm _rotatation” and “robot_drawing@product_identifier” is used to determine membership of a document of the class “robot_drawing” in a document intersection subspace. The drawing parameters define variables which can be manipulated by the CAD program, and would be used to depict the components of a particular widget (in this case, a robot).

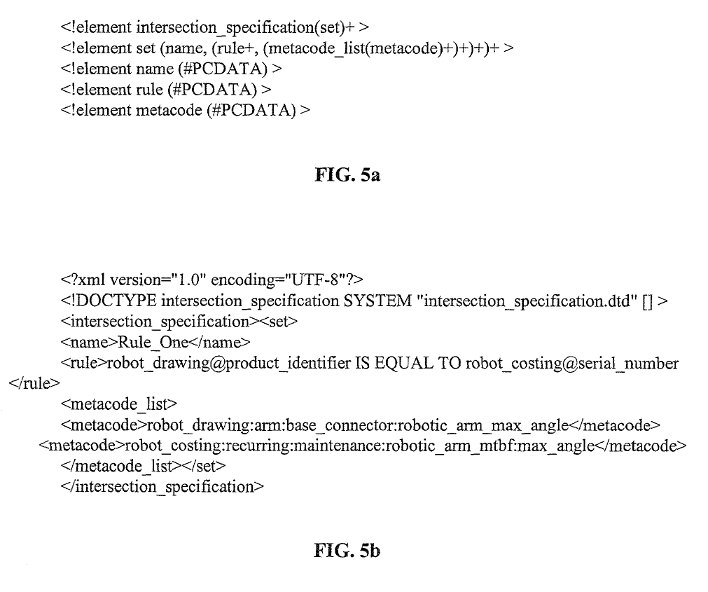

The lines of code shown in FIG. 4b define the contents of a document which is stored on access terminal 200b as “c:\robot.cad”. The document identifies itself as a member of the document class “robot_drawing”, the class definition of which is stored at “SYSTEM robot_drawing.dtd”. The variable “robot_drawing@product_identifier”=A1. Also, the drawing parameter “robotic_arm_max_angle”=45; the drawing parameter “robotic_arm_min_angle”=0; and the drawing parameter “robotic_arm_rotation”=90. The lines of code shown in FIG. 5a identify the architecture for documents of the document class “intersection_specification”. This document is stored on the database server in file “SYSTEM intersection_specification.dtd”. The code sets the format for the intersection rule records 304 and, in particular, the intersection rules which define membership within respective document intersection spaces.

The lines of code shown in FIG. 5b define the contents of a document which is stored on the database server. The document identifies itself as a member of the document class “intersection_specification”, the class definition of which is stored at “SYSTEM intersection_specification.dtd”. In other words, the document shown in FIG. 5b is an intersection rule record 304. The document states that the associated document intersection space has the name “Rule_One”, and that membership within the document intersection space is limited to documents of the class “robot costing” and documents of the class “robot_drawing”. The membership rule states that a “robot_costing” document and a “robot_drawing” document are linked within this document intersection space if the variable “serial_number” of the “robot_costing” document and the variable “product_identifier” of the “robot_drawing” identifier are equal. If documents satisfy the membership rule, then the costing parameter “robot_costing:recurring:maintenance:robotic_arm_mtbf:max_angle” and the drawing parameter “robot_drawing:arm:base_connector:robotic_arm_max_angle” of th documents are linked within an intersection subspace of the document intersection space, such that changes in one parameter will cause a corresponding change to be reflected in the associated parameter.

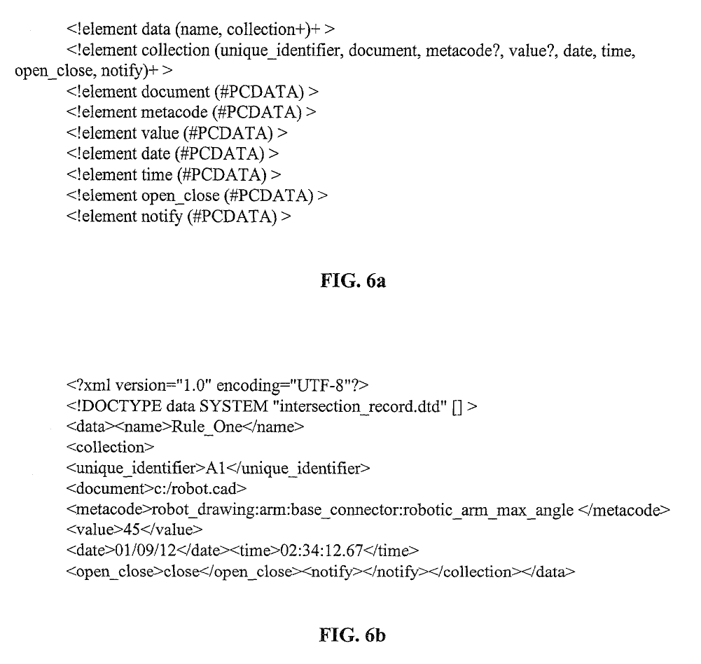

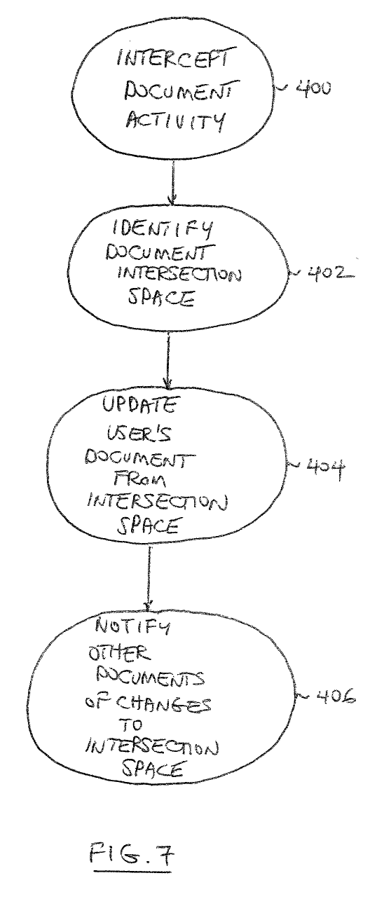

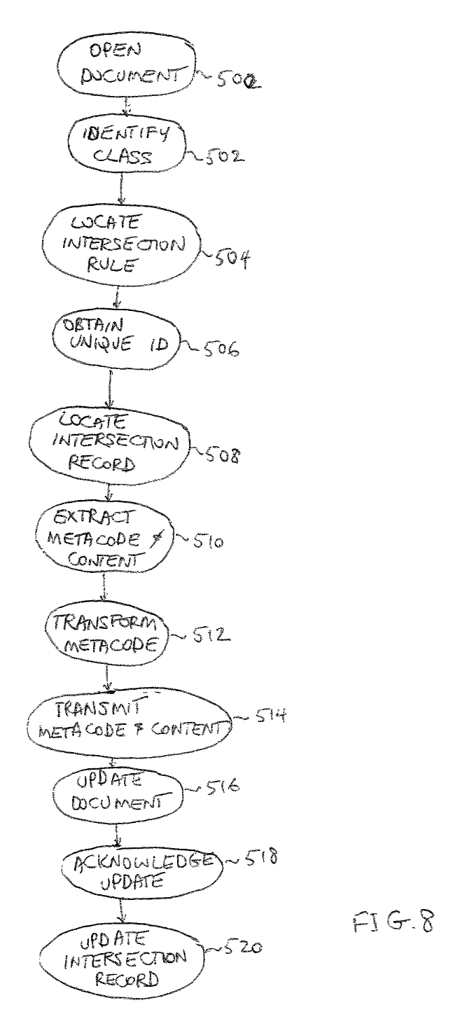

The lines of code shown in FIG. 6a identify the architecture for documents of the document class “intersection_record”. This document is stored on the database server in file “SYSTEM intersection_record.dtd”. The code sets the format for the intersection instance records 306 and, in particular, the name of the associated intersection rule, the intersection subspace identifier, and the value of the linked parameters within a document intersection subspace. In addition, the code identifies the status of the access terminal document (eg. c:\robot.cad) associated with the document intersection subspace (eg. open, closed, date/time document was last updated by its software application 216, and whether the software application 216 should be notified if the architecture or content of any other document within the document intersection subspace changes).

The lines of code shown in FIG. 6b define the contents of a document which is stored on the database server. The document identifies itself as a member of the document class “intersection_record”, the class definition of which is stored at “SYSTEM intersection_record.dtd”. In other words, the document shown in FIG. 6b is an intersection instance record 306. The document states that the record is associated with the document intersection space “Rule_One”, the intersection subspace “A1”, and the access terminal document “c:\robot.cad” (which is closed). Consequently, the document provides content for the drawing parameter “robotic_arm_max_angle “within the intersection subspace” A1”. In this case, the aforementioned drawing parameter has the value “45”.

The operation of the document management system 100 will now be described, first by way of overview, with reference to FIG. 7, and then in detail with reference to FIG. 8 and the preceding sample XML code. Initially, a user of one of the access terminals 200 uses the software application 216 on one of the access terminals 200 to open a document managed by the document management system 100. The document may reside on the access terminal 200 itself, on be available to the access terminal 200 over the communications network 106. Alternately, the user may have already opened a document, edited the document with the software application 216, and attempts to save the changes to the document. The document manager 218 of the access terminal 200 intercepts the open or save activity request at step 400, and then queries the document intersection database 300 at step 402 to identify the document intersection space associated with the changed document.

As discussed above, the document intersection database 300 may be available over the communications network 106 via a server separate from the access terminals 200, or may be spread amongst one or more of the access terminals 200. Further, as discussed above, the document manager 218 will typically determine the document class (and the intersection subspace identifier of the user's document, if assigned), evaluate each document intersection rule with the document class (and intersection subspace identifier if assigned), and then identify the document intersection space associated with the user's document by selecting the intersection space(s) for which the evaluation of the associated document intersection rule was true. However, as discussed above, the document intersection rule need not be based on the document class, but may be based instead on other relevant criteria.

After identifying the document intersection space (if any) associated with the user's document, the document manager 218 updates the identified document intersection space with the update data received from the software application 216 (if the document manager 218 has intercepted a save operation from the software application 216), and then effects an update of the user's document, at step 404, with any changes made to the document intersection space by other document managers 218 which would impact the user's document. To do so, the document manager 218 transforms the updated parameters associated with other documents of the intersection space into parameters consistent with the document architecture of the user's document. In addition, if the user had provided the document manager 218 with update data for the user's document, at step 406 the document manager 218 would optionally transform the updated parameters into parameters consistent with the document architectures of the other documents of the document intersection space, and then notify these other documents of their respective parameter changes.

For instance, if a user of the first access terminal 200a was editing a spreadsheet document with the costing parameter “robotic_arm_mtbf:max_angle”=26, and a user of the second access terminal 200b was editing a CAD document with the drawing parameter “robotic_arm_max_angle” linked in the document intersection space to the costing parameter “robotic_arm_mtbf:max_angle”, and the user of the second access terminal 200b subsequently changed the value of the drawing parameter “robotic_arm_max_angle” to 97, the document manager 218 would notify the software application 216 of the first access terminal 200a that the value of the costing parameter “robotic_arm_mtbf:max_angle” had changed from 26 to 97.

Turning now to FIG. 8, the operation of the document management system 100 will now be described with reference to the sample XML code shown in FIGS. 3 to 6. Initially, at step 500, a user of the first access terminal 200a uses a software application 216, which performs the function of a spreadsheet application, to open a document stored locally as “f:\documentsample1”. The spreadsheet software application 216 recognizes (from the DOCTYPE pointer) that the document “f:\documentsample1” is of the document class “robot_costing” and, therefore, opens the metacode definition “SYSTEM robot_costing.dtd”.

At step 502, the document manager 218 intercepts the “file open” request from the spreadsheet software application 216, and uses the DOCTYPE identifier to determine that the document “f:\documentsample1” is a member of the document class “robot_costing”. The document manager 218 then scans the intersection rule records 304 stored in the document intersection database 300, at step 504, for any records 304 whose membership rule refers to documents of the document class “robot_costing”. The document manager 218 locates the record associated with the document intersection space “Rule_One”, whose membership rule is “robot_drawing@product_identifier IS EQUAL TO robot_costing@serial_number”.

Since the located rule refers to the variable “robot_costing@serial_number”, at step 506, the document manager 218 requests that the spreadsheet software application 216 provide the document manager 218 with the value for this variable, to thereby identify the intersection subspace of the intersection space “Rule_One”. The spreadsheet software application 216 responds with the value ‘A1’ for the intersection subspace identifier.

In response, the document manager 218 scans the intersection instance records 306 stored in the document intersection database 300, at step 508, for any records 306 which satisfy the located rule, namely records 306 associated with the document intersection space “Rule_One”, and the intersection subspace “A1”. The document manager 218 locates the intersection instance record 306, shown in FIG. 6b. As discussed above, the located intersection instance record 306 specifies that it is associated with access terminal document “c:\robot.cad” (which is closed), and that the drawing parameter “robotic_arm_max_angle” within the intersection subspace “A1” has the value “45”.

Since the document “c:\robot.cad” is closed, at step 510 the document manager 218 extracts the content (45) of the drawing parameter from the <value> field, and the drawing metacode parameter (robot_drawing:arm:base_connector:robotic_arm_max_angle) from the <metacode> field. Then, at step 512, the document manager 218 queries the intersection rule record 304 associated with the intersection space “Rule_One” for the metacode parameter associated with the extracted drawing metacode. The document manager 218 obtains the costing metacode parameter “robot_costing:recurring:maintenance:robotic_arm_mtbf:max_angle”, which is, in effect, a transform of the drawing metacode parameter “robot_drawing:arm:base_connector:robotic_arm max_angle” into the document architecture of the document class “robot_costing”. The document manager 218 then transmits the transformed metacode parameter (robot costing:recurring:maintenance:robotic_arm_mtbf:max_angle) and the extracted content value (45) to the software application 216, at step 514.

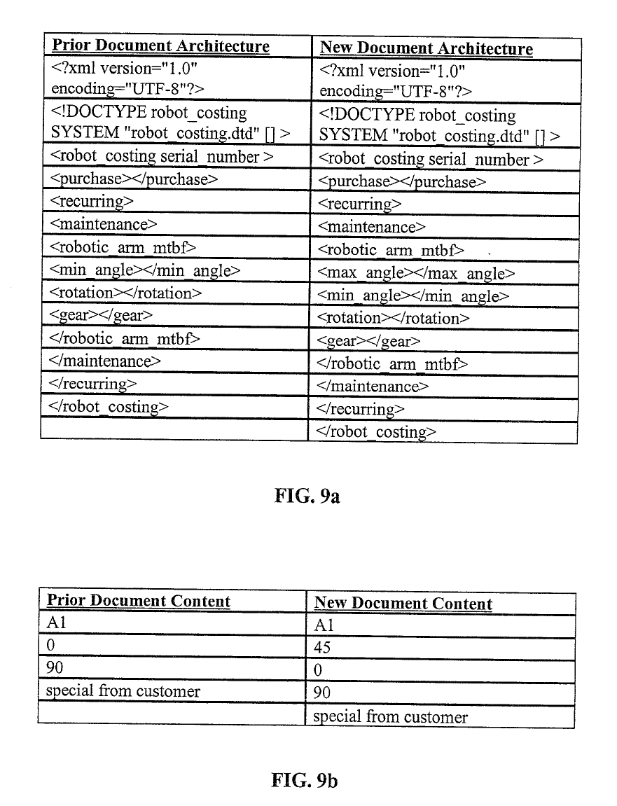

Upon receipt of the transformed metacode parameter and the extracted content value, the software application 216 examines the document's metacode class definition (in this case “SYSTEM robot_costing.dtd”). If the transformed metacode parameter is legitimate for the document's architecture, the software application 216 updates the document “f:\documentsample1”, at step 516, with the transformed metacode parameter and the extracted content value. In this instance, since the transformed metacode parameter robot_costing:recurring:maintenance:robotic_arm_mtbf:max_angle was not part of the document “f:\documentsample1”, the software application 216 updates both the architecture and the content for the document by inserting into the document the transformed metacode parameter and its content value, in accordance with the architecture defined in the document “SYSTEM robot_costing.dtd”. For convenience, FIG. 9a depicts the architecture of the document “f:\documentsample1” both before and after the update to the document. FIG. 9b depicts the content of the document “f:\documentsample1” both before and after the update to the document.

At step 518, the spreadsheet software application 216 acknowledges receipt of the transformed metacode parameter and its content value by transmitting to the document manager 218 confirmation data for insertion into the intersection instance record 306 associated with the document intersection space “Rule_One”, and the intersection subspace “A1”. The confirmation data identifies the name of the user's document (“f:\documentsample1”), the metacode parameter which was updated (“robot_costing:recurring:maintenance:robotic_arm_mtbf:max_angle”), the value of the metacode parameter (“45”), the date and time of the update, the status of the document (“open”), and whether the software application 216 should be notified (“yes”) if subsequent changes are made to the intersection space associated with this document.

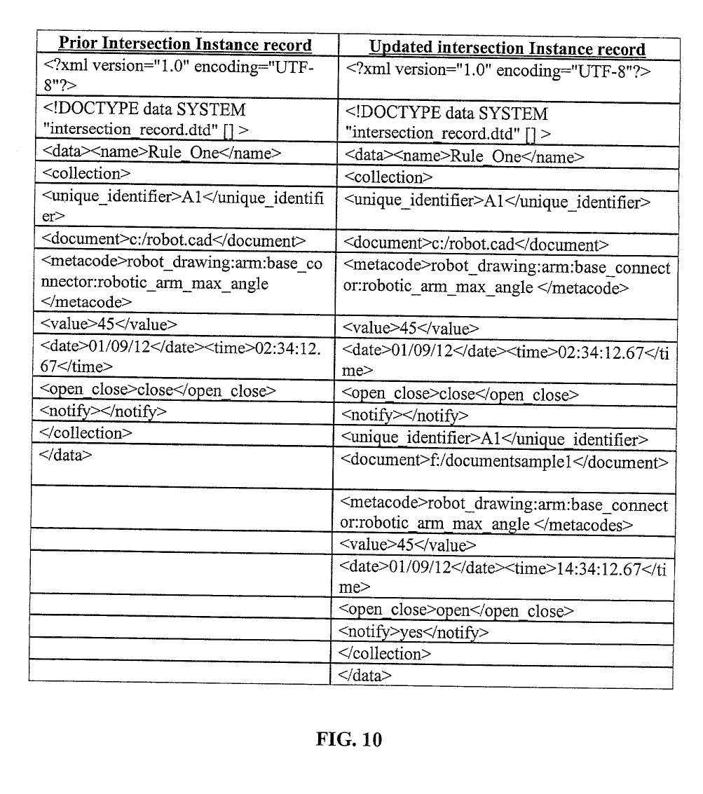

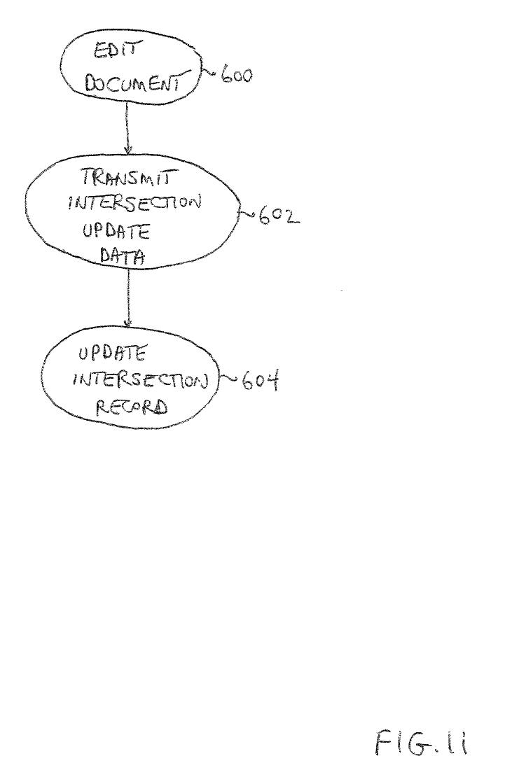

Upon receipt of the confirmation data, at step 520, the document manager 218 updates the intersection instance record 306 associated with the document intersection space “Rule_One” and the intersection subspace “A1” using the received confirmation data. In this instance, since the metacode parameter “robot_costing:recurring:maintenance:robotic_arm_mtbf:max_angle” was not part of the intersection instance record 306, the document manager 218 updates the intersection instance record 306 by inserting the confirmation data. For convenience, FIG. 10 depicts the architecture and the content of the intersection instance record 306 both before and after the update to the document “f:\documentsample1”.

The preceding discussion focused on the operation of the document management system 100 in response to a “file open” document activity indication from the first access terminal 200a. The following example continues from the preceding example, but focuses instead on the operation of the document management system 100 in response to a “file edit” document activity indication after a user of the first access terminal 200a has opened the document “f:\documentsample1”. As before, the sample XML code shown in FIGS. 3 to 6 will be used for the purposes of the discussion.

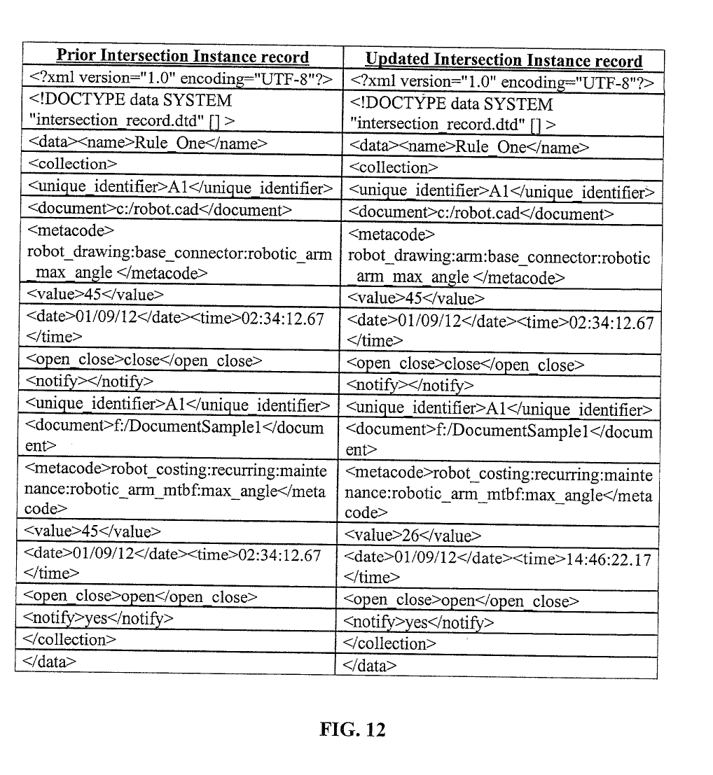

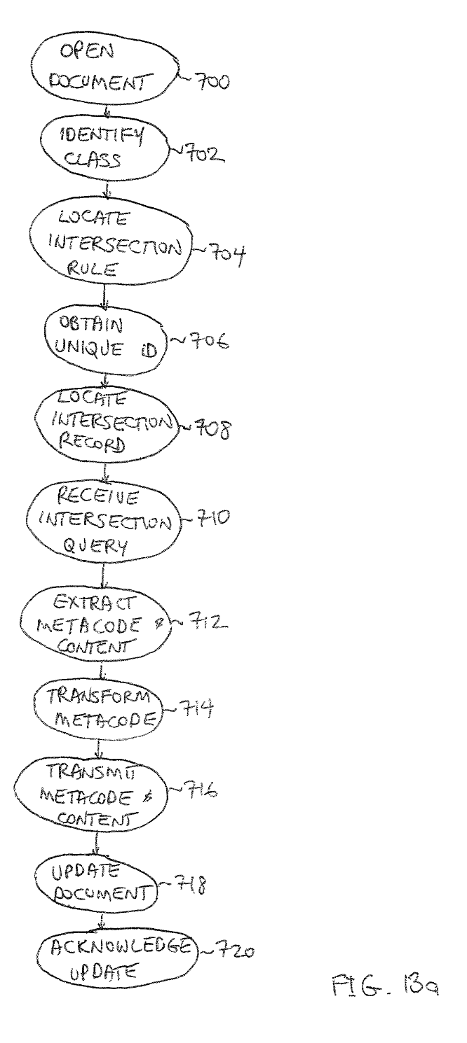

Turning now to FIG. 11, a user of the first access terminal 200a uses the spreadsheet software application 216, at step 600, to edit the document “f:\documentsample1”, for example by changing the content of metacode costing parameter “robot_costing:recurring:maintenance:robotic_arm_mtbf:max_angle” from the value ‘45’ to the value ‘26’. When the edit is complete, the spreadsheet software application 216 provides the document manager 218 with update data for the document, at step 602. The update data identifies the name of the user's document (“f:\documentsample1”), the metacode parameter which was updated (“robot_costing:recurring:maintenance:robotic_arm_mtbf:max_angle”), the value of the metacode parameter (“26”), the date and time of the update, the status of the user's document (“open”), and whether the spreadsheet software application 216 should be notified (“yes”) if subsequent changes are made to the intersection space associated with this document. Upon receipt of the update data, the document manager 218 updates the <value> field of the intersection instance record 306 associated with the document's intersection space from ‘45’ to ‘26’, at step 604. The updated intersection instance record 306 is shown in FIG. 12.

The next example will focus on the operation of the document management system 100 in response to a “file open” and a “file edit” document activity indication from the second access terminal 200b. As before, the example continues from the preceding example, and uses the sample XML code shown in FIGS. 3 to 6 for the purposes of the discussion.

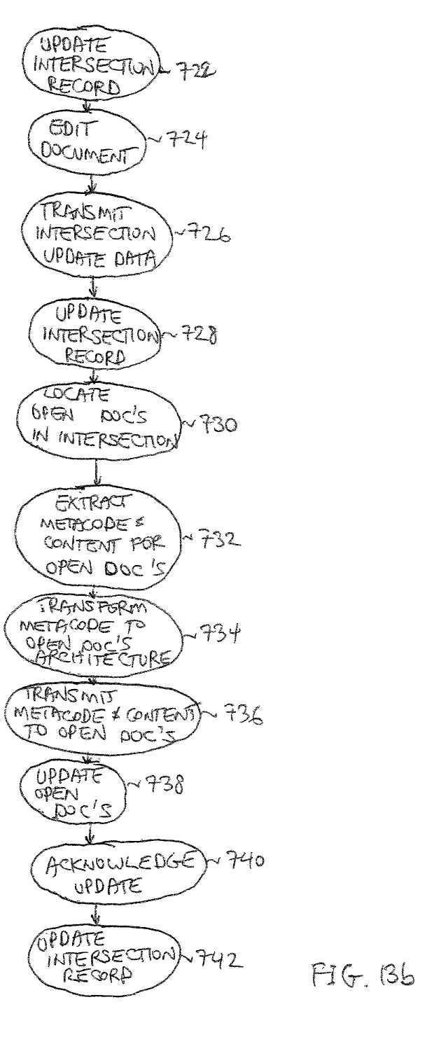

Turning to FIG. 13, at step 700, a user of the second access terminal 200b uses a software application 216, which performs the function of a CAD application, to open a document stored locally as “c:\robot.cad”. The CAD software application 216 recognizes (from the DOCTYPE pointer) that the document “c:\robot.cad” is of the document class “robot_drawing” and, therefore, opens the metacode definition “SYSTEM robot_drawing.dtd”.

At step 702, the document manager 218 of the second access terminal 200b intercepts the “file open” request from the CAD software application 216, and uses the DOCTYPE identifier to determine that the document “c:\robot.cad” is a member of the document class “robot_drawing”. The document manager 218 then scans the intersection rule records 304 stored in the document intersection database 300, at step 704, for any records 304 whose membership rule refers to documents of the document class “robot_drawing”. The document manager 218 locates the previous intersection rule record 304, namely the record associated with the document intersection space “Rule_One”, whose membership rule is “robot_drawing@product_identifier IS EQUAL TO robot_costing@serial_number”.

Since the located rule refers to the variable “robot_drawing@product_identifier”, at step 706, the document manager 218 requests that the CAD software application 216 provide the document manager 218 with the value for this variable, to thereby identify the intersection subspace of the intersection space “Rule_One”. The CAD software application 216 responds with the value ‘A1’ for the intersection subspace identifier.

In response, the document manager 218 scans the intersection instance records 306 stored in the document intersection database 300, at step 708, for any records 306 which satisfy the located rule, namely records 306 associated with the document intersection space “Rule_One”, and the intersection subspace “A1”. The document manager 218 locates the intersection instance record 306, shown in FIG. 12. The located intersection instance record 306 specifies that it is associated with the CAD document “c:\robot.cad” (which is closed), and that the drawing parameter “robotic_arm_max_angle” within the intersection subspace “A1” has the value “45”. The intersection instance record 306 also specifies that it is associated with spreadsheet document “f:\documentsample1” (which is “open”), and that the costing parameter “robotic_arm_mtbf:max_angle” within the same intersection subspace (which is therefore linked to the drawing parameter “robotic_arm_max_angle”) has the value ‘26’.

Since the document “f:\documentsample1” is open, the document manager 218 notifies the CAD software application 216, at step 710, that there is an open document in the intersection space associated with the CAD document “c:\robot.cad”, and the CAD software application 216 requests the document manager 218 to provide the contents of the <value> field of the costing parameter “robotic_arm_mtbf:max_angle” in the intersection space. If there had been more than one open document in the intersection space, the document manager 218 would have notified the CAD software application 216 of the number of open intersections, and the CAD software application 216 would have qualified its request for the contents of field <value> by specifying, for instance, that the fields <date> and <time> be the most current.

At step 712, the document manager 218 extracts the content (26) of the costing parameter from the <value> field, and the costing metacode parameter (robot_costing:recurring:maintenance:robotic_arm_mtbf:max_angle) from the <metacode> field. Then, at step 714, the document manager 218 queries the intersection rule record 304 associated with the intersection space “Rule_One” for the metacode parameter associated with the extracted costing metacode. The document manager 218 obtains the drawing metacode parameter “robot_drawing:arm:base_connector:robotic_arm_max_angle”, which is, in effect, a transform of the costing metacode parameter “robot_costing:recurring:maintenance:robotic_arm_mtbf:max_angle” into the document architecture of the document class “robot_drawing”. The document manager 218 then transmits the transformed metacode parameter (robot_drawing:arm:base_connector:robotic_ann_max_angle) and the extracted content value (26) to the CAD software application 216, at step 716.

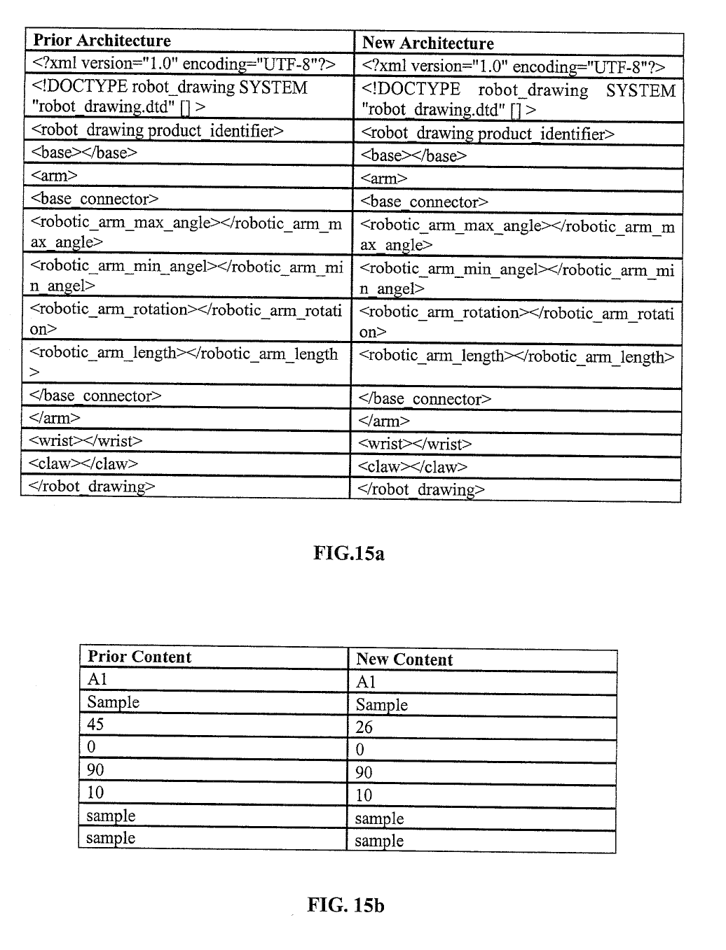

Upon receipt of the transformed metacode parameter and the extracted content value, the CAD software application 216 examines the document's metacode class definition (in this case “SYSTEM robot_drawing.dtd”). If the transformed metacode parameter is legitimate for the document's architecture, the CAD software application 216 updates the document “c:\robot.cad”, at step 718, with the transformed metacode parameter and the extracted content value. For convenience, FIG. 15a depicts the architecture of the document “c:\robot.cad” both before and after the update to the document. FIG. 15b depicts the content of the document “c:\robot.cad” both before and after the update to the document.

At step 720, the CAD software application 216 acknowledges receipt of the transformed metacode parameter and its content value by transmitting to the document manager 218 confirmation data for insertion into the intersection instance record 306 associated with the document intersection space “Rule_One” and the intersection subspace “A1”. The confirmation data identifies the name of the user's document (“c:\robot.cad”), the metacode parameter which was updated (“robot_drawing:arm:base_connector:robotic_arm_max_angle”), the value of the metacode parameter (“26”), the date and time of the update, the status of the document (“open”), and whether the CAD software application 216 should be notified (“yes”) if subsequent changes are made to the intersection space associated with this document.

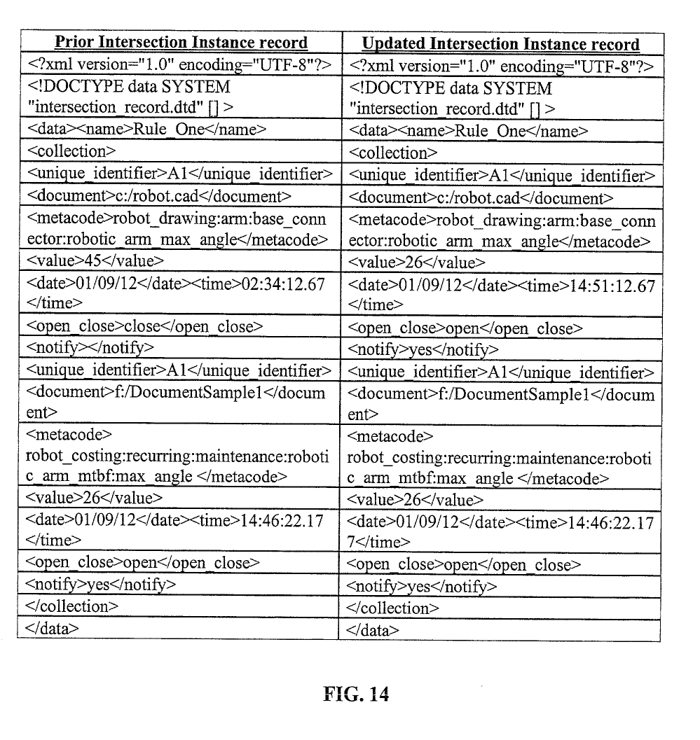

Upon receipt of the confirmation data, at step 722, the document manager 218 updates the intersection instance record 306 associated with the document intersection space “Rule_One” and the intersection subspace “A1” using the received confirmation data. For convenience, FIG. 14 depicts the architecture and the content of the intersection instance record 306 both before and after the update to the document “c:\robot.cad”.

After the intersection instance record 306 has been updated, the document “c:\robot.cad” is formally open, and the user of the second access terminal 200b uses the CAD software application 216, at step 724, to edit the document “c:\robot.cad”, for example by changing the content of metacode costing parameter “robot_drawing:arm:base_connector:robotic_arm_max_angle” from the value ‘26’ to the value ‘97’. When the edit is complete, the CAD software application 216 provides the document manager 218 with update data for the CAD document, at step 726. The update data identifies the name of the user's document (“c:\robot.cad”), the metacode parameter which was updated (“robot drawing:arm:base_connector:robotic_arm_max_angle”), the value of the metacode parameter (“97”), the date and time of the update, the status of the user's document (“open”), and whether the CAD software application 216 should be notified (“yes”) if subsequent changes are made to the intersection space associated with this document.

Upon receipt of the update data, the document manager 218 updates the <value> field of the intersection instance record 306 associated with the document's intersection space from ‘26’ to ‘97’, at step 728. The document manager 218 then scans the intersection instance record 306, at step 730, to identify any other documents which are members of the associated document intersection space, have an <open_close> value of ‘open’ and a <notify> value of ‘yes’. The document manager 218 identifies the document “f:/documentsample1” as meeting the specified criteria and selects that entry.

At step 732, the document manager 218 extracts the content (97) of the drawing parameter from the <value> field, and the drawing metacode parameter (robot_drawing:arm:base_connector:robotic_arm_max_angle) from the <metacode> field. Then, at step 734, the document manager 218 queries the intersection rule record 304 associated with the intersection space “Rule_One” for the metacode parameter associated with the extracted drawing metacode. The document manager 218 obtains the costing metacode parameter “robot_costing:recurring:maintenance:robotic_arm_mtbf:max_angle”, which is, in effect, a transform of the drawing metacode parameter “robot_drawing:arm:base_connector:robotic_arm_max_angle” into the document architecture of the document class “robot_costing”. The document manager 218 then transmits the transformed metacode parameter (robot_costing:recurring:maintenance:robotic_arm_mtbf:max_angle) and the extracted content value (26) to the spreadsheet software application 216, at step 736.

At step 738, the spreadsheet software application 216 updates the spreadsheet document “f:\documentsample1” with the transformed metacode parameter and its content value, and then acknowledges receipt of the transformed metacode parameter and its content value, at step 740, by transmitting to the document manager 218 confirmation data for insertion into the intersection instance record 306 associated with the document intersection space “Rule_One”, and the intersection subspace “A1”. The confirmation data identifies the name of the user's document (“f:\documentsample1”), the metacode parameter which was updated (“robot_costing:recurring:maintenance:robotic_arm_mtbf max_angle”), the value of the metacode parameter (“97”), the date and time of the update, the status of the document (“open”), and whether the software application 216 should be notified (“yes”) if subsequent changes are made to the intersection space associated with this document.

If the document manager 218 does not receive the confirmation data (for example, if the communications network 106 failed, the first access terminal 200a became disconnected from the communications network 106, or the spreadsheet software application 216 became inoperative) within a predetermined time interval, the document manager 218 resets the intersection instance record 306 associated with the document's intersection space by setting the <open_close> value for the document “f:\documentsample1” to ‘close’, and the <notify> value for the same document to null. This setting forces the spreadsheet software application 216 to initialize a new session with the document manager 218 when the first access terminal 200a comes back online, by forcing the spreadsheet software application 216 to request content from the document's intersection space, as described with reference to FIG. 8.

On other hand, if the document manager 218 does receive the confirmation data, at step 742, the document manager 218 updates the intersection instance record 306 associated with the document intersection space “Rule_One” and the intersection subspace “A1” using the received confirmation data.

The present invention is defined by the claims appended hereto, with the foregoing description being illustrative of a preferred embodiment of the invention. Those of ordinary skill may envisage certain additions, deletions and/or modification to the described embodiment which, although not specifically described herein, do not depart from the scope of the invention, as defined by the appended claims.

We claim:

1. A method of managing a plurality of electronic documents, comprising the steps of:
receiving over a network a document activity indication of one of the electronic documents;
identifying a document intersection space associated with the one electronic document, the document intersection space defining at least one of document architecture data and document content data of the one electronic document and at least one other of the documents associated with the one electronic document, the architecture data defining a document architecture of the associated document, the content data defining content for the associated document; and
effecting an update of the one electronic document over the network from the document data of the document intersection space.

2. The method according to claim 1, wherein each said electronic document has a document class, each said document intersection space has a document intersection rule, each said document intersection rule defining membership within the document intersection space from the document classes, and the document intersection space identifying step comprises the steps of determining the document class of the one document, evaluating each said document intersection rule with the determined document class, and determining the associated document intersection space from the intersection rule evaluation.

3. The method according to claim 2, wherein each said electronic document has a document identifier, each said document intersection rule defines the document intersection space from the document identifiers, and the evaluating step comprises evaluating each said document intersection rule with the document identifier associated with the one electronic document.

4. The method according to claim 1, wherein the update effecting step comprises the steps of providing a transform of the document data of the at least one other document, the transform document data being consistent with the document architecture of the one electronic document, and transmitting the transform document data over the network to the one electronic document.

5. The method according to claim 4, wherein the update effecting step further comprises the steps of receiving over the network confirmation data in confirmation of the transmitted transform document data, and updating the associated document intersection space with the confirmation data.

6. The method according to claim 5, wherein the confirmation data comprises at least one of the document content data and the document architecture data of the one electronic document.

7. The method according to claim 1, wherein the document activity indication comprises at least one of the document content data and the document architecture data of the one electronic document, the activity indication receiving step comprises receiving the document data from the one electronic document, and the update effecting step comprises the steps of updating the associated document intersection space with the received document data, providing a transform of the received document data, the transform document data being consistent with the document architecture of the at least one other document, and transmitting the transform document data to the at least one other documents.

8. A method of managing a plurality of electronic documents, comprising the steps of:
receiving a document activity indication of one of the electronic documents;
from a document intersection database comprising at least one document intersection record, identifying an associated one of the document intersection records associated with the one document, the associated one document intersection record defining at least one of document architecture data and document content data of the one document and at least one other of the documents associated with the one document, the architecture data defining a document architecture of the associated document, the content data defining content for the associated document; and
providing document update data in accordance with the document intersection data.

9. The method according to claim 8, wherein each said document is a member of a document class, the document intersection database includes at least one document intersection rule, each said document intersection rule defining membership within a document intersection space comprising associated ones of the document classes, and the intersection record identifying step comprises the steps of identifying the document class of the one document, evaluating each said document intersection rule with the identified document class, from the intersection rule evaluations identifying the document intersection space associated with the identified document class, and determining the associated one document intersection record from the identified document intersection space.

10. The method according to claim 9, wherein each said document intersection record defines an intersection subspace of at least one of the document intersection spaces, the intersection subspace comprising associated ones of the documents within the associated at least one document intersection space, and the intersection record determining step comprises the steps of receiving a document subspace identifier associated with the one document, and determining the document intersection subspace from the document subspace identifier and the identified document intersection space.

11. The method according to claim 8, wherein the update data comprises a transform of the document data of the at least one other document, the transform document data being consistent with the document architecture of the one electronic document.

12. The method according to claim 11, wherein the update data providing step comprises the steps of receiving confirmation data in confirmation of the transmitted transform document data, and updating the associated document intersection record with the confirmation data.

13. The method according to claim 8, wherein the document activity indication comprises at least one of the document content data and the document architecture data of the one electronic document, the activity indication receiving step comprises receiving the document data from the one electronic document, and the update data providing step comprises the steps of updating the associated document intersection record with the received document data, providing a transform of the received document data, the transform document data being consistent with the document architecture of the at least one other document, and transmitting the transform document data to the at least one other documents.

14. A document management system for managing a plurality of documents, the document management system comprising:
a document intersection database defining a document intersection space for the documents, one of the document intersection spaces defining at least one of document architecture data and document content data of the one document and at least one other of the documents associated with the one document, the architecture data defining a document architecture of the associated document, the content data defining content for the associated document; and
a document manager in communication with the document intersection database, and being configured to update the one document intersection space with the document data received from the one document and to notify the other of the documents of the update to the one document intersection space.

15. A document management system for managing a plurality of documents, the document management system comprising:
a document intersection database comprising at least one document intersection record, one of the document intersection records defining at least one of document architecture data and document content data of one of the documents and at least one other of the documents associated with the one document, the architecture data defining a document architecture of the associated document, the content data defining content for the associated document; and
a document manager in communication with the document intersection database, and being configured to update the one document intersection record with the document data received from the one document and to notify the other of the documents of the update to the one document intersection record.

16. A document intersection database for use by a document management system for managing a plurality of documents, the database comprising:
an intersection rule database including at least one intersection rule record, each said intersection rule record defining a document intersection space comprising one of the documents and at least one other of the documents associated with the one document, the document intersection space defining a map between document architecture data of the one document and the at least one other associated documents; and
an intersection instance database including at least one intersection instance record, each said intersection instance record being associated with one of the document intersection spaces and defining document content for the document architecture of the one document intersection space.

17. A computer-readable medium for providing processing instructions in a computer, the processing instructions causing the computer to perform the steps of:
receiving over a network a document activity indication of one of the electronic documents;
identifying a document intersection space associated with the one electronic document, the document intersection space defining at least one of document architecture data and document content data of the one electronic document and at least one other of the documents associated with the one electronic document, the architecture data defining a document architecture of the associated document, the content data defining content for the associated document; and
effecting an update of the one electronic document over the network from the document data of the document intersection space.

18. A computer-readable medium for providing processing instructions in a computer, the processing instructions causing the computer to perform the steps of:
receiving a document activity indication of one of the electronic documents;
from a document intersection database comprising at least one document intersection record, identifying an associated one of the document intersection records associated with the one document, the associated one document intersection record defining at least one of document architecture data and document content data of the one document and at least one other of the documents associated with the one document, the architecture data defining a document architecture of the associated document, the content data defining content for the associated document; and
providing document update data in accordance with the document intersection data.
